(19) United States
(12) Patent Application Publication
(10) Pub. No.: US 2026/0315951 A1
(43) Pub. Date: Oct. 15, 2026

(54) COMBINED FOG MACHINE AND SNOW MACHINE

(71) Applicant: SHENZHEN QIAOHUA INDUSTRIES LIMITED., SHENZHEN (CN)

(72) Inventors: RUIMIAN YANG, SHENZHEN (CN); RUIBAO CHEN, SHENZHEN (CN); WENLI YANG, SHENZHEN (CN); XIANHUA LIU, SHENZHEN (CN); YUANCHENG OU, SHENZHEN (CN); JUN CAO, SHENZHEN (CN)

(21) Appl. No.: 19/317,669

(22) Filed: Sep. 3, 2025

(30) Foreign Application Priority Data
Apr. 11, 2025 (CN) 202520696458.9

(51) Int. Cl. A63J 5/02; A63H 33/28

(52) U.S. Cl. CPC A63J 5/025; A63H 33/28; A63J 5/028

(57) ABSTRACT

A combined fog machine and snow machine includes at least one film-forming nozzle having a liquid inlet pipe and a fog channel, a liquid conveying assembly, a fog conveying assembly, and a film scraping body. A diameter of the fog channel is not greater than 10 mm. The liquid conveying assembly is communicated with the liquid inlet pipe. The liquid conveying assembly is configured to convey a bubble liquid to the liquid inlet pipe. The fog conveying assembly is communicated with the fog channel. The fog conveying assembly is configured to convey fog to the fog channel. The film scraping body is disposed adjacent to the at least one film-forming nozzle. At least one film scraping rod is disposed on the film scraping body. When the film scraping body rotates, the at least one film scraping rod rotates to pass the liquid inlet pipe and the fog channel.

### TECHNICAL FIELD

The present disclosure relates to a field of bubble blowing technology, and in particular to a combined fog machine and snow machine.

### BACKGROUND

Snow machines are devices configured to produce artificial snowflakes, which are commonly used to create a romantic atmosphere for stage performances, weddings, and location filming. Conventional snow machines commonly use snow liquid to produce foamy artificial snowflakes, resulting in a limited visual effect. Furthermore, the foamy artificial snowflakes need to be produced by high pressure, so the conventional snow machines generally have a problem of high noise.

Fog bubble machine are devices configured to produce different visual effects, such as bubbles, fog, haze, and fog-filled bubbles. The fog bubble machines are also widely used to create a romantic atmosphere for stage performances, weddings, and location filming. Conventional bubble machines commonly generate the fog by heating a fog liquid. Therefore, the conventional bubble machines do not produce noise during operation. Therefore, combining advantages of the conventional snow machines and the conventional smoke bubble machines, the present disclosure proposes a combined fog machine and snow machine that adopts the same operating principles as the conventional bubble machines but is further able to produce small fog-filled bubbles to simulate a visual effect of snowflakes.

### SUMMARY

The present disclosure provides a combined fog machine and snow machine. The combined fog machine and snow machine comprises at least one film-forming nozzle having a liquid inlet pipe and a fog channel, a liquid conveying assembly, a fog conveying assembly, and a film scraping body. A diameter of the fog channel is not greater than 10 mm. The liquid conveying assembly is connected to and communicated with the liquid inlet pipe. The liquid conveying assembly is configured to convey a bubble liquid to the liquid inlet pipe. The fog conveying assembly is connected to and communicated with the fog channel. The fog conveying assembly is configured to convey fog to the fog channel. The film scraping body is disposed adjacent to the at least one film-forming nozzle and is rotatable relative to the at least one film-forming nozzle. A least one film scraping rod is disposed on the film scraping body. When the film scraping body rotates, the at least one film scraping rod rotates to pass the liquid inlet pipe and the fog channel.

When in operation, the liquid conveying assembly conveys the bubble liquid to each liquid inlet pipe. Simultaneously, the fog conveying assembly conveys the fog to each fog channel. The bubble liquid flowing out of each liquid inlet pipe and the fog flowing out of the fog channel then form fog-filled bubbles after being scraped by the at least one film scraping rod. Because the diameter of each fog channel is not greater than 10 mm, the fog-filled bubbles are relatively small, visually creating an effect of snowflakes. Alternatively, the liquid conveying assembly is not in operation, and the combined fog machine and snow machine directly outputs the fog. Alternatively, the fog conveying assembly is not in operation, the combined fog machine and snow machine directly produces air-filled bubbles. Compared to conventional snow machines, the combined fog machine and snow machine of the present disclosure is capable of producing a variety of visual effects, such as haze, fog, air-filled bubbles, large-scale simulated snowflakes, and small-scale simulated snowflakes. Furthermore, the combined fog machine and snow machine of the present disclosure does not generate noise during operation, enhancing a user experience.

### BRIEF DESCRIPTION OF DRAWINGS

FIG. 1 is a perspective schematic diagram of a combined fog machine and snow machine according to a first embodiment of the present disclosure.

FIG. 2 is another perspective schematic diagram of the combined fog machine and snow machine according to the first embodiment of the present disclosure.

FIG. 3 is an exploded schematic diagram of the combined fog machine and snow machine according to the first embodiment of the present disclosure, where a housing thereof is removed.

FIG. 4 is an exploded schematic diagram of a first mounting plate and part of a fog conveying assembly of the combined fog machine and snow machine according to the first embodiment of the present disclosure.

FIG. 5 is another exploded schematic diagram of the first mounting plate and part of the fog conveying assembly of the combined fog machine and snow machine according to the first embodiment of the present disclosure.

FIG. 6 is an enlarged schematic diagram of area A shown in FIG. 4.

FIG. 7 is a partial perspective schematic diagram of the combined fog machine and snow machine according to the first embodiment of the present disclosure.

FIG. 8 is a perspective schematic diagram of a fog collecting box of the combined fog machine and snow machine according to the first embodiment of the present disclosure.

FIG. 9 is another perspective schematic diagram of the fog collecting box of the combined fog machine and snow machine according to the first embodiment of the present disclosure.

FIG. 10 is a cross-sectional schematic diagram of a multi-way pipe of the fog collecting box of the combined fog machine and snow machine according to the first embodiment of the present disclosure.

FIG. 11 is a perspective schematic diagram of the combined fog machine and snow machine according to a second embodiment of the present disclosure.

FIG. 12 is a perspective schematic diagram of the combined fog machine and snow machine according to a third embodiment of the present disclosure.

### DETAILED DESCRIPTION

In order to make objectives, technical solutions, and advantages of the present disclosure clearer, the following further describes the present disclosure in detail with reference to accompanying drawings and embodiments. It should be understood that the specific embodiments described here are only used to explain the present disclosure, but not to limit the present disclosure.

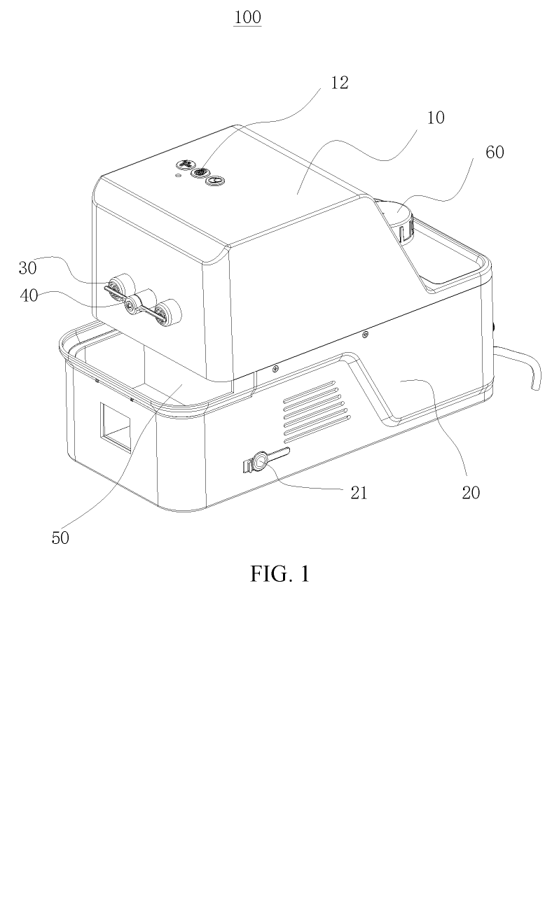

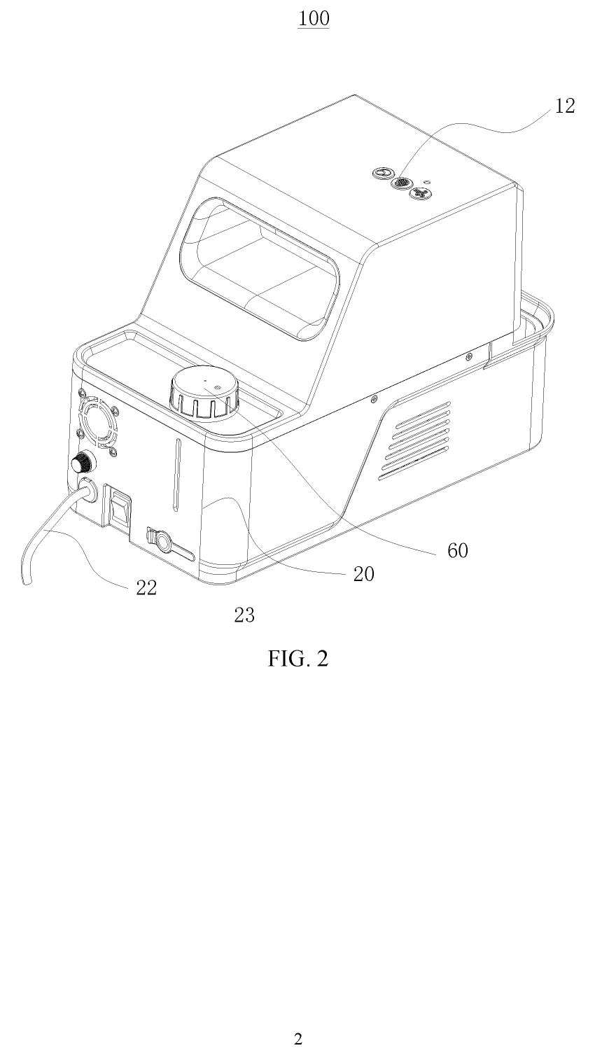

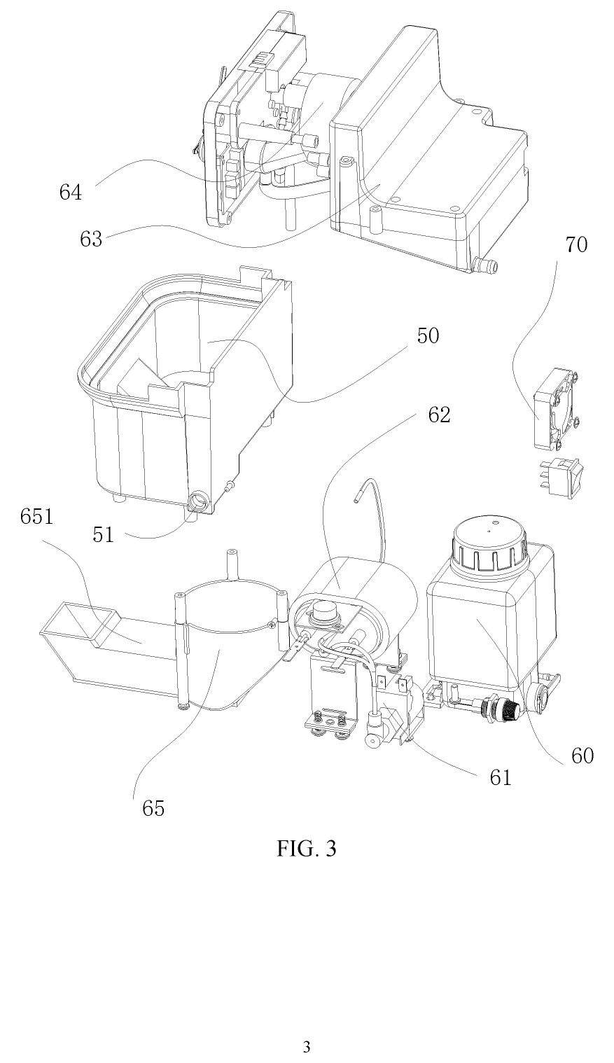

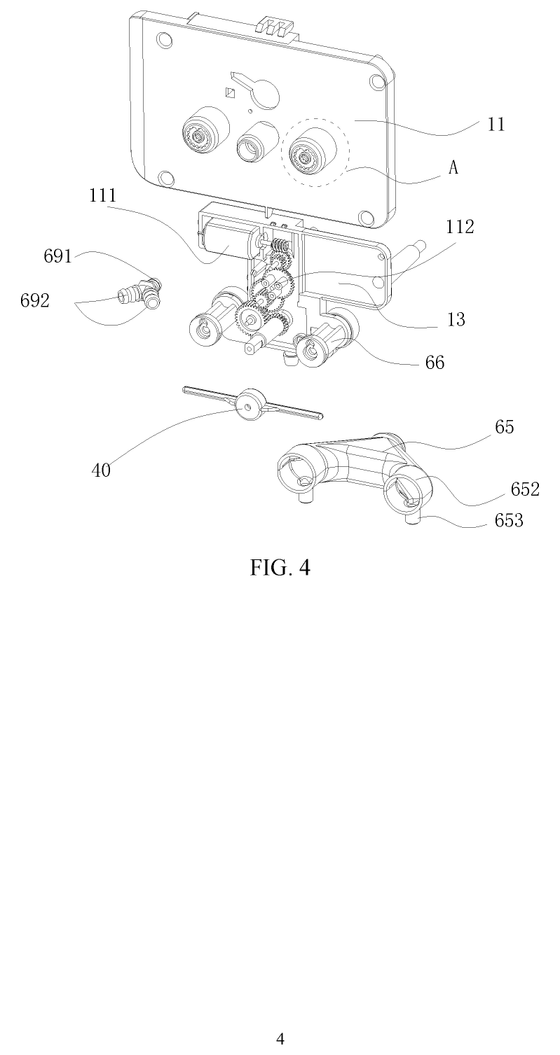

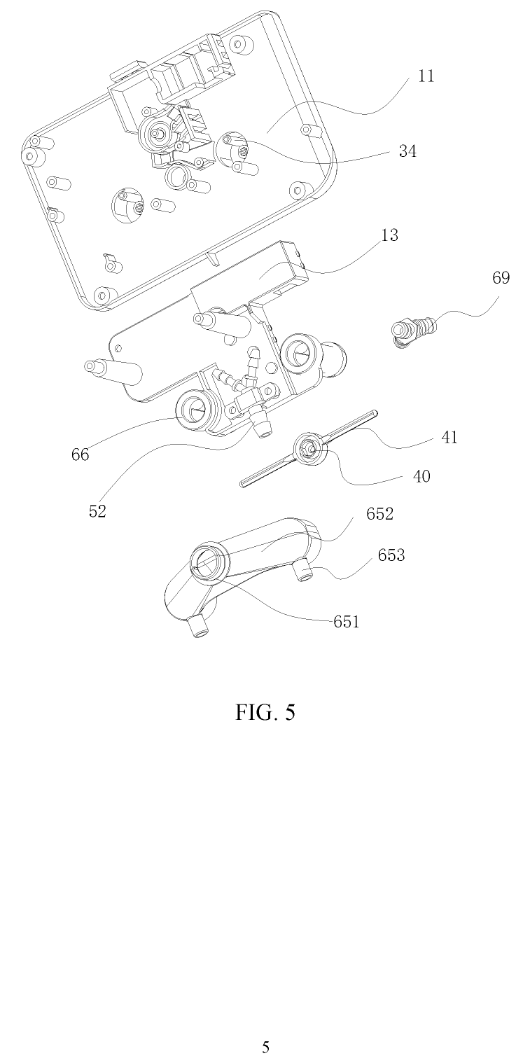

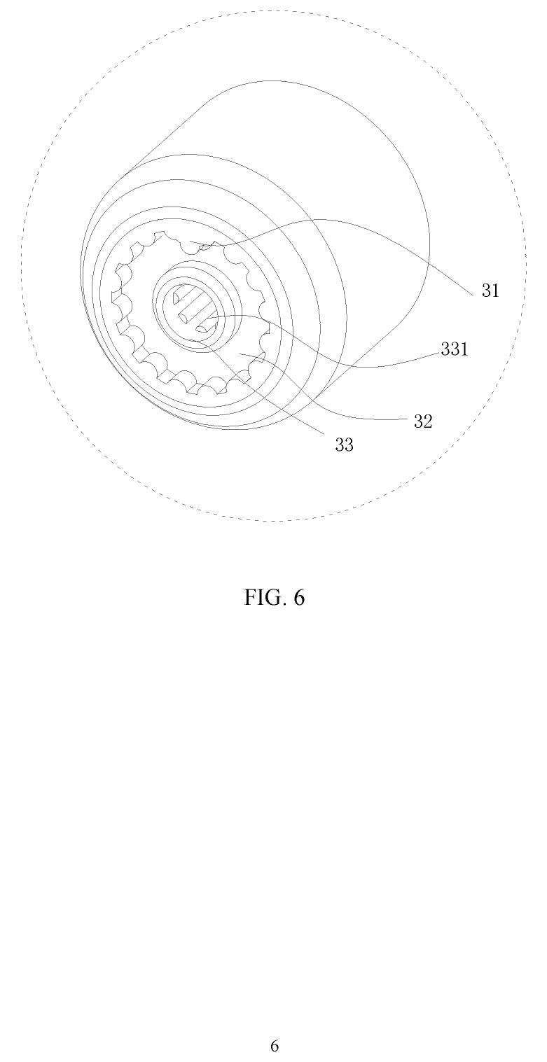

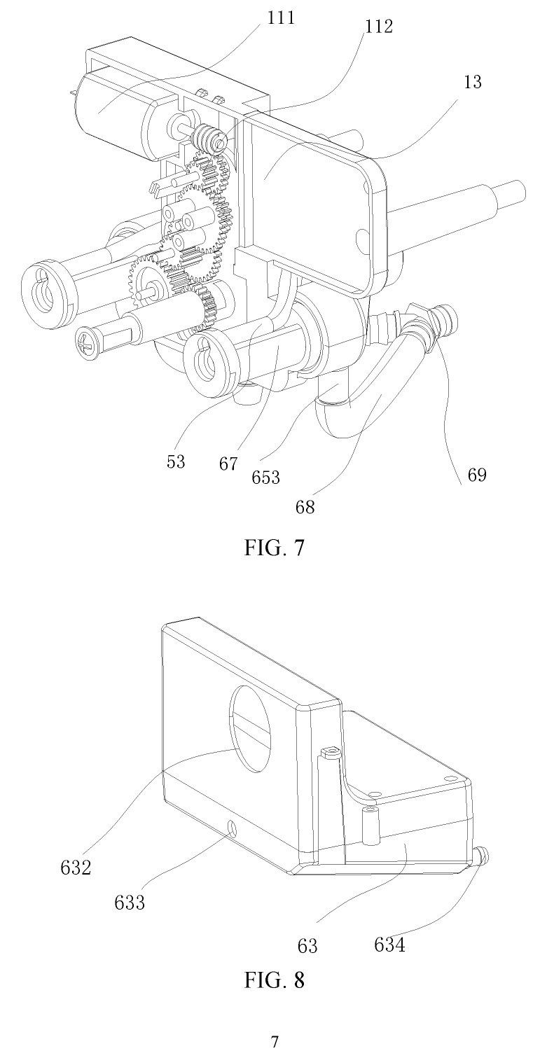

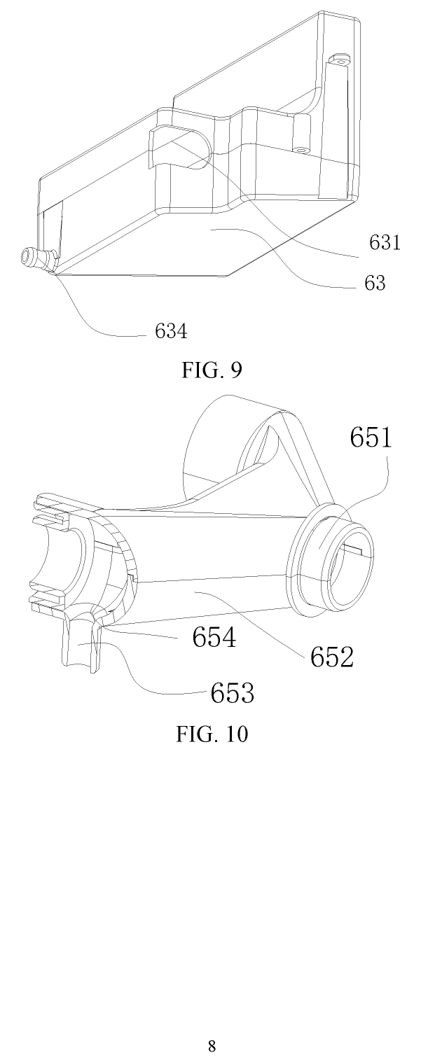

As shown in FIGS. 1-12, the present disclosure provides a combined fog machine and snow machine 100, which combines effects of a conventional fog bubble machine and a conventional snow machine. The combined fog machine and snow machine 100 is configured to produce air-filled bubbles, fog, haze, and fog-filled bubbles. The combined fog machine and snow machine 100 is used to create a romantic atmosphere for stage performances, weddings, and location filming, etc.

Specifically, the combined fog machine and snow machine 100 comprises at least one film-forming nozzle 30, a liquid conveying assembly, a fog conveying assembly, and a film scraping body 40. The at least one film-forming nozzle 30 comprises a film-forming space 32, a liquid inlet pipe 34 and a fog channel 33. The liquid inlet pipe 34 is communicated with the fog channel 33 and the film-forming space 32. A diameter of the fog channel 33 is not greater than 10 mm. The liquid conveying assembly is connected to and communicated with the liquid inlet pipe 34. The liquid conveying assembly is configured to convey a bubble liquid to the liquid inlet pipe 34. The fog conveying assembly is connected to and communicated with the fog channel 33. The fog conveying assembly is configured to convey fog to the fog channel 33. The film scraping body 40 is disposed adjacent to the at least one film-forming nozzle 30 and is rotatable relative to the at least one film-forming nozzle 30. A least one film scraping rod 41 is disposed on the film scraping body 40. When the film scraping body 40 rotates, the at least one film scraping rod 41 rotates at a fixed frequency to pass the film-forming space 32, so as to form a bubble film on a surface of the film-forming space 32.

When in operation, the liquid conveying assembly conveys the bubble liquid to the liquid inlet pipe 34. Simultaneously, the fog conveying assembly conveys fog to the fog channel 33. The bubble liquid flowing from the liquid inlet pipe 34 and the fog flowing from the fog channel 33 then converge in the film-forming space 32 to form the fog-filled bubbles. Because the diameter of the fog channel is not greater than 10 mm, the fog-filled bubbles are relatively small, simulating a visual effect of snowflakes.

In one embodiment, when the liquid conveying assembly is not in operation, and the combined fog machine and snow machine 100 directly outputs the fog. Alternatively, when the fog conveying assembly is not in operation, the combined fog machine and snow machine 100 directly produces the air-filled bubbles. Compared to the conventional snow machine, the combined fog machine and snow machine 100 of the present disclosure is capable of producing a variety of visual effects, such as haze, the fog, the air-filled bubbles, large-scale simulated snowflakes, and small-scale simulated snowflakes. Furthermore, the combined fog machine and snow machine 100 of the present disclosure does not generate noise during operation, enhancing a user experience.

In one embodiment, the at least one film-forming nozzle does not have the film-forming space 32. The at least one film scraping rod 41 directly passes the liquid inlet pipe 34 to form the bubble film. Under an action of air pressure, the fog flowing out of the fog channel is wrapped in the bubble film to form a fog-filled bubble.

It should be noted that the diameter of the fog channel is optionally between 3-7 mm, so as to produce smaller fog-filled bubbles, making it easier to create the visual effect of snowflakes. If the diameter of the fog channel is less than 3 mm, the film-forming space is very small, making it difficult to form bubbles on the surface of the film-forming space. The fog is simply escaped from the fog channel, no fog-filled bubbles are produced to simulate the snowflakes, and the fog snowflake machine 100 is unable to be served as a bubble machine. If the diameter of the fog channel is greater than 10 mm, sizes of the fog-filled bubbles are large, an observer may easily realize that the fog-filled bubbles are bubbles instead of snowflakes. The fog channel having the diameter of 3-10 mm is capable of producing the fog-filled bubbles that are more suitable for simulating the snowflakes.

In one embodiment, the at least one film-forming nozzle 30 comprises film-forming nozzles 30. The number of film-forming nozzles 30 affects the scale of the simulated snowflakes that the combined fog machine and snow machine is able to produce. When there is only one film-forming nozzle 30, fewer fog-filled bubbles are produced per unit time, failing to create a large-scale snowflake visual effect. Excessive film-forming nozzles, on the other hand, require more connecting components, hindering the miniaturization of the combined fog machine and snow machine. Therefore, in the embodiment, two film-forming nozzles are provided, which ensure both a high speed for generating the simulated snowflakes and a compact design.

In one embodiment, arc-shaped teeth 331 are evenly disposed on a peripheral wall of each fog channel 33. A small amount of dust particles are mixed in the fog. When the fog flows out of each fog channel 33, part of the dust particles is attached to the arc-shaped teeth 331, making the fog-filled bubbles lighter to better simulate the snowflakes.

The fog conveying assembly comprises fog inlet pipes 66, a multi-way pipe 65, and a fog collecting box 63. Each of the fog inlet pipes 66 is sleeved in a corresponding one of the film-forming nozzles 30. Each of the fog inlet pipes 66 is communicated with a corresponding fog channel 33. The multi-way pipe 65 comprises a main channel 651 and branch channels 652 communicated with the main channel 651. A first end of the main channel 651 is communicated with the fog collecting box 63. A second end of the main channel 651 is connected to a first end of each of the branch channels 652. A second end of each of the branch channels 652 is sleeved and communicated with a corresponding one of the fog inlet pipes 66. The fog flowing out of the fog collecting box 63 sequentially flows through the main channel 651 and each of the branch channels 652 and is guided into each of the fog inlet pipes 66 by each of the branch channels 652.

In one embodiment, a return pipe 653 extends downward from a bottom portion of each of the branch channels 652. Each return pipe 653 is disposed close to the second end of a corresponding one of the branch channels 652. Each return pipe 653 is communicated with and connected to the fog collecting box 63. Part of the fog is condensed during a flow process to form a condensed fog liquid. Each return pipe 653 is configured to guide the condensed fog liquid to return to the fog collecting box 63. In this way, the condensed fog liquid is prevented from accumulating in the two film-forming nozzles 30 or the fog inlet pipes 66. Therefore, the fog always reaches each film-forming space 32 smoothly, ensuring a normal operation of the combined fog machine and snow machine 100.

In one embodiment, the fog conveying assembly further comprises a multi-way joint 69 and connecting pipes 68. The multi-way joint 69 comprises a first joint 691 and second joints 692 communicated with the first joint 691. The first joint 691 is connected to and communicated with the fog collecting box 63. Each of the second joints 692 is connected to and communicated with a corresponding return pipe 653 by a corresponding one of the connecting pipes 68.

In a vertical direction, the multi-way joint 69 is located below each return pipe 653, so the condensed fog liquid flowing out of each return pipe 653 is allowed to flow toward the multi-way joint 69 under the action of gravity.

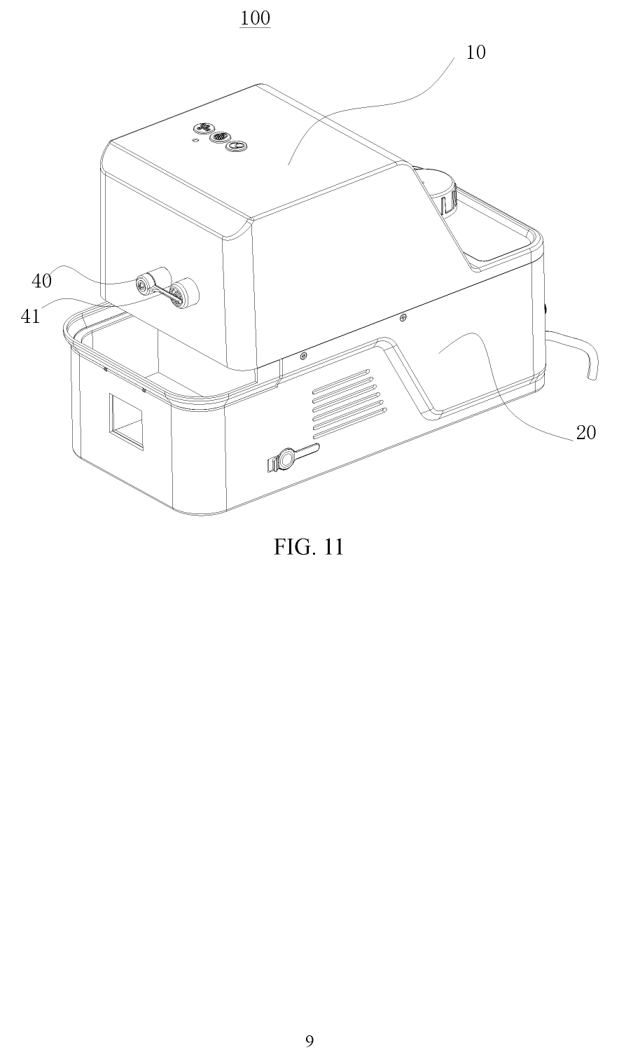

It should be noted that the number of the second joints 692 of the multi-way joint 69 is equal to the number of the branch channels 652 and the number of the film-forming nozzles 30. For example, when there are two film-forming nozzles 30, the multi-way pipe 65 comprises two branch channels 652, and the multi-way pipe 65 is Y-shaped as a whole. Similarly, the multi-way joint 69 is a three-way joint including two second joints 692, and the three-way joint is also Y-shaped as a whole. In an alternate embodiment, as shown in FIG. 11, when there is only one film-forming nozzle 30, the multi-way pipe 65 is a linear pipe, and one return pipe 653 is directly connected to the fog collecting box 63 through one connecting pipe 68 or is connected to the fog collecting box 63 through a linear two-way joint. In another alternate embodiment, when there are three film-forming nozzles 30, the multi-way pipe 65 is a four-way pipe with three branch channels 652, and the multi-way joint 69 is a four-way joint. Of course, as mentioned above, when the number of film-forming nozzles 30 exceeds three, it is detrimental to the miniaturized design of the combined fog machine and snow machine 100, so the present disclosure excludes a solution where more than three film-forming nozzles 30 are provided.

In one embodiment, each return pipe 653 defines a return port 654. Each return port 654 is defined on a bottom wall of a corresponding one of the branch channels 652 and is inclined relative to the bottom wall of the corresponding one of the branch channels 652. The condensed fog liquid is allowed to flow into each return pipe 653 along each return port 654 under gravity. By configuring the return port 654 on each of the branch channels, the condensed fog liquid in the multi-way pipe 65 is allowed to flow naturally toward each return pipe 653.

In one embodiment, the fog conveying assembly further comprises a fog liquid pump 61, a fog liquid reservoir 60, a heater 62, and the fog collecting box 63. The fog liquid reservoir 60 is configured to store the fog liquid. The fog liquid pump 61 is configured to pump the fog liquid from the fog liquid reservoir 60 and transfer the fog liquid to the heater 62. The heater 62 is configured to heat the fog liquid and atomize the fog liquid to produce the fog. The fog collecting box 63 is configured to collect the fog. After the fog is discharged from the fog collecting box 63, the fog reaches locations where bubble films are formed. As the bubble films gradually forms bubbles due to a pressure difference, the fog flows into the bubbles, thereby forming the fog-filled bubbles. Optionally, the fog liquid pump 61 and a guide pipe are connected between the fog liquid reservoir 60 and the heater 62. In other embodiments, the fog liquid pump 61 is not provided. Instead, by setting a height difference between the fog liquid reservoir 60 and the heater 62, the fog liquid from the fog liquid reservoir 60 is able to flow directly to the heater 62 under the action of gravity.

The fog collecting box 63 comprises an inlet 631, an outlet 632, a fog liquid inlet 633, and a fog liquid outlet 634. The inlet 631 is connected to the heater 62 to receive the fog generated by the heated fog liquid. The outlet 632 is connected to the multi-way pipe 65. The fog formed by the heated fog liquid is allowed to flow from the inlet 631 of the fog collecting box 63 and flow out through the outlet 632 of the fog collecting box 63. In the vertical direction, the fog liquid outlet 634 is located at a lowest point of the fog collecting box 63, and the fog liquid outlet 634 is communicated with the fog liquid reservoir 60. Because the fog liquid outlet 634 is located at the lowest point of the fog collecting box 63, both the condensed fog liquid formed in the fog collecting box and the condensed fog liquid flowing from the fog liquid inlet 633 are allowed to flow to the fog liquid outlet 634 under the action of gravity. The fog liquid outlet 634 is communicated with the fog liquid reservoir 60, thereby facilitating reuse of the condensed fog liquid.

In one embodiment, the fog conveying assembly further comprises a first airflow drive 64. The first airflow drive 64 is connected between the multi-way pipe 65 and the fog collecting box 63. The first airflow drive 64 is configured to suck out the fog from the fog collecting box 63 and drive the fog to flow toward positions where the bubble films are formed. Specifically, the first airflow drive 64 is a first fan. The first fan is connected to the fog collecting box 63 and the multi-way pipe 65. The branch channels 652 of the multi-way pipe 65 are one-to-one connected to the fog inlet pipes 66, and each of the fog inlet pipes 66 is connected to the corresponding one of the film-forming nozzles 30 and is communicated with the corresponding fog channel 33. Therefore, the fog sucked out by the first fan quickly flows into the main channel 651 and is split by the branch channel 652. Then, the fog flows into each of the fog inlet pipes 66 and finally reaches the fog channel 33 of each of the film-forming nozzles 30. Since each fog channel is connected to a corresponding film-forming space 32, the fog reaches the bubble film formed at a port of each film-forming space 32 and is wrapped by the bubble film under the pressure difference to form the fog-filled bubble having a small size. In this way, the fog-filled bubbles are produced to simulate the visual effect of snowflakes.

In one embodiment, the liquid conveying assembly comprises a bubble liquid reservoir 50, liquid conveying pipes 53, and a bubble liquid pump 52. The bubble liquid reservoir 50 is configured to store a bubble liquid. The bubble liquid pump 52 is connected to the bubble liquid reservoir 50 and the liquid conveying pipes 53. Each of the liquid conveying pipes 53 is connected to a corresponding liquid inlet pipe 34. The bubble liquid pump 52 is configured to pump the bubble liquid to the liquid conveying pipes 53. Driven by a pumping force, the bubble liquid entering each of the liquid conveying pipes 53 further flows into the corresponding liquid inlet pipe and then flows into a corresponding film-forming space 32. The bubble liquid then contacts a corresponding film scraping rod 41 located at one end of each film-forming space 32 to form the bubble film. In the embodiment, due to an action of the bubble liquid pump 52, the bubble liquid flowing into each liquid inlet pipe 34 still has a certain impact force. To prevent the bubble liquid from forming a water column and directly spraying out from each film-forming space 32, film-forming teeth 31 are disposed on a peripheral wall of each film-forming space 32. The film-forming teeth 31 of each film-forming space 32 partially block a corresponding liquid inlet pipe 34. In this way, the film-forming teeth 31 not only offset the impact force of the bubble liquid in each film-forming space 32, but also reduce a flow rate of the bubble liquid in each film-forming space 32, which is conducive to the formation of the bubble films.

In one embodiment, the mist and snow machine 100 further comprises a second airflow driver 65 configured to generate an airflow. The airflow directs generated bubbles away from the mist and snow machine 100, thereby preventing the bubbles from accumulating and colliding near the mist and snow machine 100. In some embodiments, the second airflow driver 65 is a second fan. The mist and snow machine 100 further comprises an airflow duct 651 connected to the second airflow driver 65. The airflow duct 651 is configured to adjust a direction of the airflow generated by the second airflow driver 65.

In one embodiment, the mist and snow machine 100 comprises a housing. The housing comprises a first mounting shell 10 and a second mounting shell 20. The first mounting shell 10 and the second mounting shell 20 jointly define a mounting cavity. The fog liquid reservoir 60 of the mist conveying assembly is partially mounted within the mounting cavity. For example, a main body of the fog liquid reservoir 60 is mounted within the mounting cavity, while a cap of the fog liquid reservoir 60 is exposed outside the mounting cavity. Therefore, when refilling the fog liquid, a user does not need to disassemble the mist and snow machine 100; instead, the user is able to simply unscrew the cap to add fog liquid directly, which is very convenient to operate. All components of the fog conveying assembly, except for the fog liquid reservoir 60, are completely mounted within the mounting cavity. Similarly, the bubble solution reservoir 50 is partially mounted within the mounting cavity. A top portion of the bubble solution reservoir 50 defines an opening, and the opening is partially exposed outside the mounting cavity. Therefore, when refilling the bubble liquid, the user is able to directly pour the bubble liquid into the bubble solution reservoir 50 from the opening of the bubble solution reservoir 50, which is very quick and convenient.

In addition, since the bubble liquid is relatively cheap, when the mist and snow machine 100 is not used, in order to avoid a problem of a remaining bubble liquid flowing out of the bubble solution reservoir 50 into the mounting cavity due to improper placement of the mist and snow machine 100, in one embodiment, a first drain hole 51 is defined on a bottom portion of the bubble solution reservoir 50. A second drain hole corresponding to the first drain hole is defined on the second mounting shell 20. The second mounting shell 20 further comprises a sealing plug 21 movably connected to the second mounting shell 20. After assembling, a main body of the bubble solution reservoir 50 abuts against inner walls of the second mounting shell 20. During use, the sealing plug 21 seals the first drain hole 51 and the second drain hole, and the bubble liquid is stored in the bubble solution reservoir 50. After used, the user is able to pull the sealing plug 21 out of the first drain hole 51 and the second drain hole to drain the bubble liquid.

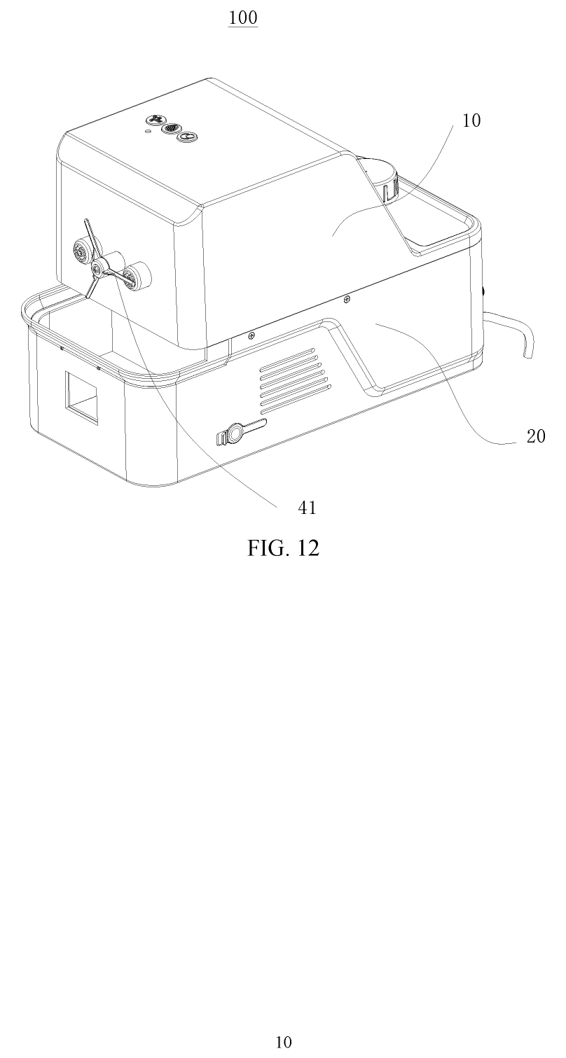

In one embodiment, the first mounting shell 10 comprises a mounting panel 11, and the film-forming nozzles 30 and the film scraping body 40 are mounted on an outer wall of the mounting panel 11. Specifically, the film-forming nozzles 30 are integrally formed with the mounting panel 11. The film scraping body 40 is detachably connected to the mounting panel 11. The user is able to replace the film scraping body 40 with another film scraping body 40 having a different number of the film scraping rods 41 according to actual needs. Therefore, the mist and snow machine 100 of the present disclosure is able to create various snowflake visual effects. For example, when a dense snowflake effect needs to be displayed, the film scraping body 40 with three film scraping rods 41 (as shown in FIG. 12) is used, and when only a sparse snowflake effect is required, the film scraping body 40 with a single film scraping rod 41 (as shown in FIG. 11) is used. It should be noted that when there are two or more film scraping rods 41, the film scraping rods 41 are disposed at equal angles around a rotation center of the film scraping body 40, which ensures that the bubble films are produced at an equal time interval.

Furthermore, a density and a color depth of the fog-filled bubbles are adjusted by adjusting a rotation frequency of the film scraping body 40. Specifically, the mist and snow machine 100 further comprises a drive mechanism and an encapsulation shell 13. The encapsulation shell 13 is configured to encapsulate the drive mechanism on an inner wall of the mounting panel 11, thereby preventing the drive mechanism from being exposed. Therefore, the service life of the drive mechanism is extended. The drive mechanism comprises a gear set 112 and a motor 111. The gear set 112 and the motor 111 are in transmission connection with the film scraping body 40. The motor 111 is a fixed-frequency motor 111. In this case, an output frequency of the motor 111 is fixed, and the at least one film scraping rod 41 of the film scraping body 40 passes through each film-forming space 32 at a fixed frequency. Therefore, when more than one film scraping rod is provided, the more the film scraping rods 41, the faster the bubble film is formed in each film-forming space 32, the less mist is wrapped in the bubble film. As a result, a denser and lighter snowflake effect is provided. Conversely, the fewer the film scraping rods 41, the slower the bubble film is formed, resulting in a sparser, more colorful snowflake effect.

Of course, the motor 111 may be a variable-frequency motor 111. In this case, the film scraping body 40 is able to rotate with different frequencies. That is, when the number of the film scraping rods 41 of the film scraping body 40 is fixed, different snowflake effects are created by adjusting a frequency of the motor 111. In the mist and snow machine 100 of the present disclosure, the motor 111 is optionally the variable-frequency motor 111. On this premise, by replacing the film scraping body 40 with another with another film scraping body 40 having different numbers of the film scraping rods 41, the mist and snow machine 100 of the present disclosure is able to create rich and diverse snowflake effects.

In one embodiment, the mist and snow machine 100 further comprises a controller (not shown) and buttons 12. The controller is electrically connected to the buttons 12, the drive mechanism, the mist conveying assembly, and the liquid conveying assembly. The controller is configured to control a motor speed and an operating state of the mist and snow machine 100. The user is able to switch the mist and snow machine 100 between different operating states by controlling the buttons 12. For example, by pressing different buttons 12, the mist and snow machine 100 is able to output only mist, only air-filled bubbles, or different snowflake effects. Therefore, the mist and snow machine 100 is suitable for a wide range of usage scenarios.

In one embodiment, the mist and snow machine 100 further comprises a cooling fan 70 mounted in the mounting cavity. The cooling fan 70 is configured to dissipate heat within the mist and snow machine 100.

Foregoing descriptions are only optional embodiments of the present disclosure and are not intended to limit the present disclosure. Any modification, equivalent replacement, or improvement within the technical scope of the present disclosure should be included in the protection scope of the present disclosure.

What is claimed is:

1. A combined fog machine and snow machine, comprising:
at least one film-forming nozzle having a liquid inlet pipe and a fog channel;
a liquid conveying assembly;
a fog conveying assembly; and
a film scraping body;
wherein a diameter of the fog channel is not greater than 10 mm;
wherein the liquid conveying assembly is connected to and communicated with the liquid inlet pipe, and the liquid conveying assembly is configured to convey a bubble liquid to the liquid inlet pipe;
wherein the fog conveying assembly is connected to and communicated with the fog channel, and the fog conveying assembly is configured to convey fog to the fog channel;
wherein the film scraping body is disposed adjacent to the at least one film-forming nozzle and is rotatable relative to the at least one film-forming nozzle, at least one film scraping rod is disposed on the film scraping body, and when the film scraping body rotates, the at least one film scraping rod rotates to pass the liquid inlet pipe and the fog channel.

2. The combined fog machine and snow machine according to claim 1, wherein the at least one film-forming nozzle further comprises a film-forming space, wherein the liquid inlet pipe is communicated with the fog channel and the film-forming space, and when the at least one film scraping body rotates, the at least one film scraping rod rotates to pass the film-forming space.

3. The combined fog machine and snow machine according to claim 1, wherein the at least one film-forming nozzle comprises film-forming nozzles, and when the at least one film scraping body rotates, the at least one film scraping rod rotates to pass the film-forming nozzles.

4. The combined fog machine and snow machine according to claim 3, wherein the at least one film scraping rod comprises film scraping rods, and the film scraping rods are evenly disposed around a rotation center of the film scraping body.

5. The combined fog machine and snow machine according to claim 1, wherein the diameter of the fog channel is 3-7 mm.

6. The combined fog machine and snow machine according to claim 3, wherein the fog conveying assembly comprises fog inlet pipes, a multi-way pipe, and a fog collecting box;
wherein each of the fog inlet pipes is sleeved in a corresponding one of the film-forming nozzles, and each of the fog inlet pipes is communicated with a corresponding fog channel;
wherein the multi-way pipe comprises a main channel and branch channels communicated with the main channel, a first end of the main channel is communicated with the fog collecting box, a second end of the main channel is connected to a first end of each of the branch channels, a second end of each of the branch channels is sleeved and communicated with a corresponding one of the fog inlet pipes, and the fog flowing out of the fog collecting box sequentially flows through the main channel and each of the branch channels and is guided into each of the fog inlet pipes by each of the branch channels.

7. The combined fog machine and snow machine according to claim 6, wherein a return pipe extends downward from a bottom portion of each of the branch channels, each return pipe is disposed close to the second end of a corresponding one of the branch channels, each return pipe is communicated with and connected to the fog collecting box, part of the fog is condensed during a flow process to form a condensed fog liquid, and each return pipe is configured to guide the condensed fog liquid to return to the fog collecting box.

8. The combined fog machine and snow machine according to claim 7, wherein the fog conveying assembly further comprises a multi-way joint and connecting pipes, wherein the multi-way joint comprises a first joint and second joints communicated with the first joint, the first joint is connected to and communicated with the fog collecting box, and each of the second joints is connected to and communicated with a corresponding return pipe by a corresponding one of the connecting pipes.

9. The combined fog machine and snow machine according to claim 7, wherein each return pipe defines a return port, each return port is defined on a bottom wall of a corresponding one of the branch channels and is inclined relative to the bottom wall of the corresponding one of the branch channels, and the condensed fog liquid is allowed to flow into each return pipe along each return port under gravity.

10. The combined fog machine and snow machine according to claim 7, wherein the fog conveying assembly further comprises a fog liquid reservoir configured to store a fog liquid, and the fog liquid is configured to from the fog;
wherein the fog collecting box comprises an inlet, an outlet, a fog liquid inlet, and a fog liquid outlet, the fog formed by the fog liquid is allowed to flow from the inlet of the fog collecting box and flow out through the outlet of the fog collecting box, and the fog liquid inlet is communicated with each return pipe;
wherein in a vertical direction, the fog liquid outlet is located at a lowest point of the fog collecting box, and the fog liquid outlet is communicated with the fog liquid reservoir.
